(19) United States
(12) Patent Application Publication
(10) Pub. No.: US 2004/0085315 A1
(43) Pub. Date: May 6, 2004

(54) Texture partition and transmission method for network progressive transmission and real-time rendering by using the wavelet coding algorithm

(75) Inventors: Ding-Zhou Duan, Kaohsiung Hsien (TW); Shu-Kai Yang, Tainan (TW); Ming-Fen Lin, Hsinchu (TW)

Correspondence Address: MERCHANT & GOULD PC, P.O. BOX 2903, MINNEAPOLIS, MN, 55402-0903, US

(73) Assignee: INDUSTRIAL TECHNOLOGY RESEARCH INSTITUTE, Hsinchu Hsien (TW)

(21) Appl. No.: 10/373,411

(22) Filed: Feb. 24, 2003

(30) Foreign Application Priority Data
Nov. 5, 2002 (TW) 091132557

(51) Int. Cl. G06T 17/00

(52) U.S. Cl. 345/428

(57) ABSTRACT

A texture partition and transmission method for network progressive transmission and real-time rendering by using the Wavelet Coding Algorithm is disclosed. An image to be applied on a mesh is firstly partitioned into multiple image tiles. After that, each image tile is further converted by the use of Wavelet Coding Algorithm to a data string that can represent multiple resolution levels of the image. Further, the mesh is also divided into multiple tiles to respectively correspond to the partitioned image tiles. After the feature parameter of each mesh tile is obtained, the rendering resolution of the image tile, which is intended to be pasted on the mesh tile, can be determined by the feature parameter.

### BACKGROUND OF THE INVENTION

1. Field of the Invention

The invention is related to a texture partition and transmission method for network progressive transmission and real-time rendering by the use of Wavelet Coding Algorithm, and more particularly to a transmission method that is applied to the three-dimension (3-D) applications.

2. Description of Related Arts

Virtual Reality (VR) and 3-D applications are now in widespread use in many fields, for example, in the computer games or the education software. However, 3D images are still difficult to popularize over the Internet because of their extremely large size in data to be stored. When users download such a 3-D scene to the personal computer by the present telecommunication techniques, a long transfer time is required and that is usually expensive in telecommunication charges. Moreover, such an 3D scene transmission and procession is a gigantic load for the image display hardware, such as a display interface card. Therefore, a new technique for creating an image having a plurality of levels with different resolutions for use in rendering the image using in 3D application is developed to solve the mentioned problems. One vital purpose of the technique is that the objects in the 3D scene, which are inconspicuous or far away from the viewpoint of a user, are treated as less important when compared with other objects so that they are represented by fuzzy appearance with low resolution. So both the data transmission load over the processing hardware and the transmission time are minimized, and the texture images using in 3D scene still retains acceptable display resolution.

In recent years one commonly used image compression is JPEG compression standard for 2-D image. Although image size is able to be minimized, such a compressing standard still has some disadvantages. For example, an image to be compressed must be firstly divided into multiple blocks, such as 8×8 blocks, and then respectively converted and compressed. When increasing the compression ratio to obtain a smaller size, a problem of blocking distortion, also known as blocking artifact, will occur in the image.

In order to overcome the problem, a new technique with low bit rate transmission ability becomes the latest developing course in the image or video processing field now. For example, a well known compression standard entitled JPEG 2000 adopts Wavelet Coding technique to replace the original DCT (discrete cosine transform) that is applied in the conventional JPEG compression standard. The low bit rate transmission technique provides many image displaying options, such as progressive transmission, resolution setting and transmission rate setting. Some image processing manners related to the Wavelet Coding are described as follows.

RGB/YUV conversion: Generally, an original color image, which is not compressed yet, is able to be represented by RGB plane (red, green and blue colors). However, RGB plane is not suitable to apply in most image compression systems because of the high color mutuality. That means when a single color is compressed individually, the remaining two colors need to be considered simultaneously. So the entire compression efficiency is hard to improve. Instead of the RGB plane, most compression systems utilize another color system named YUV plane, where Y means luminance, U and V mean chrominance. Because the mutuality among Y, U and V is low as compared with the RGB plane, this compressing system is preferably used. Since human eyes are very sensitive to the luminance (Y) than the chrominance (U and V), Y is designed to have a higher percentage than U and V. Usually, the ratio of the luminance (Y) to the chrominance (U and V) is Y:U:V=4:2:2 or 4:1:1. As an example to obtain the ratio 4:1:1, in every four sample pixels, U and V can be taken from one pixel among the four sample ones, and Y is taken from all sample pixels.

According to the CCIR 601 standard, the conversion between RGB and YUV is expressed by the following matrix:

$$( \begin{matrix}Y \\ U \\ V\end{matrix} ) = [ \begin{matrix}0.299 & 0.5 & 0.114 \\ - 0.147 & - 0.289 & 0.436 \\ 0.615 & - 0.515 & - 0.1\end{matrix} ] ( \begin{matrix}R \\ G \\ B\end{matrix} )$$

S+P transform: To achieve the progressive transmission, which means an image to be displayed is capable of becoming much clearer from a fuzzy outline during its transmission process, S+P transform is adopted.

With reference to FIG. 8, the conception of S+P transform is illustrated. Firstly, the image is converted to a pyramid configuration having a plurality of levels, as shown from the level 0 to level N (two levels in this example). When the pyramid configuration is sequentially transmitted from level N to level 0, the image is gradually rendered as a clear image from the fuzzy outline.

In the S+P transform, an image is deemed as being composed of a series of numbers. The series is expressed by c[n], where n=0, . . . , N−1, N. The series c[n] can be further expressed by the two following equations (1) and (2) together:

$$\begin{matrix}l [ n ] = \{ \frac{c ( 2 n ) + c ( 2 n + 1 )}{2} \} , n = 0 , … , \frac{N}{2} - 1 & ( 1 ) \\ h [ n ] = c ( 2 n ) - c ( 2 n + 1 ) , n = 0 , … , \frac{N}{2} - 1 & ( 2 )\end{matrix}$$

The above two equations (1) and (2) are deemed as the S-transform of the series c[n], wherein each data point l[n] means an average value of two adjacent numbers and each data point h[n] means an difference value between two adjacent numbers. With reference to FIG. 9, when the column S-transform and the row S-transform are alternately performed on a 2-D image, a pyramid configuration with multiple levels is obtained.

As shown in FIG. 9, the left top corner that is designated with “ll” that contains the most data points, i.e. average numbers. The remaining levels lh, hl and hh are for modifying the displayed image to become much clear.

However after the S-transform, a great mutuality exists among all h[ ] of each level, and this leads the series h[ ] to be unable to converge. In order to solve this problem, a predictive coding function is applied in the S-transform and this combination is entitled as S+P transform. The prediction way is firstly to calculate a predictor ĥ[ ] of the series h[ ].

The predictor ĥ[ ] is calculated based on the following equation (3),

$$\hat{h} [ n ] = {\sum }_{i - L}^{L} {α}_{i} Δ l [ n + i ] - {\sum }_{j - 1}^{H} {β}_{j} h [ n + j ] wherein , \qquad ( 3 )$$

Δl[n]=l[n−1]−l[n], and αᵢ, βⱼ are predictor coefficients.

$${h}_{d} [ n ] = h [ n ] - \{ \hat{h} [ n ] + \frac{1}{2} \} , n = 0 , 1 , … , \frac{N}{2} - 1 \qquad ( 4 )$$

Then, the difference value h_{d}[ ] (as shown in equation (4)) between the predictor ĥ[ ] and the real value h[ ] is employed to replace the original h[ ]. The difference value h_{d}[ ] would be much more convergent than the h[ ] thereby increasing the efficiency of data compression.

In equation (3), the two predictor coefficients α and β are determined by some factors that includes entropy, variance and frequency domain. The predictor coefficients are usually classified to three different categories A, B and C based on their application field.

Category A has the lowest calculation complexity, category B is applied on the natural image processing and category C is suitable to the medical image that requires an extremely high resolution.

Since most compressed images belong to natural images, the B type predictor coefficient is preferably adopted and equation (3) is rewritten as the following equation (5):

$$\hat{h} [ n ] = \frac{1}{8} \{ 2 ( Δ l [ n ] + Δ l [ n + 1 ] ) + Δ l [ n + 1 ] , \qquad ( 5 )$$

wherein at the image borders,

$$\hat{h} [ 0 ] = \frac{Δ l [ 1 ]}{4} , \hat{h} [ \frac{N}{2} - 1 ] = \frac{Δ l [ \frac{N}{2} - 1 ]}{4} .$$

With reference to FIG. 10, the entire S+P transform process is illustrated. The series c[ ] is transferred by the S transform to generate the l[ ] and h[ ] and then to calculate the predictor ĥ[ ] based on the generated l[ ] and h[ ]. After which, ĥ[ ] and h[ ] are further processed to obtain the difference h_{d}[ ], so the final transmitted data only contains the h_{d}[ ] and l[ ].

With reference to FIG. 11, the pyramid configuration having plural levels is obtained from the S+P transform, in which a parent-child relationship exists between two adjacent levels. When sorting all levels in the pyramid configuration, each level must be endowed with a weighting value to keep all levels have the the approximately significant unitary. For example, each different level as shown in FIG. 8 must be multiplied with a corresponding weighting value as shown in FIG. 12.

SPIHT (Set Partitioning in Hierarchical Trees): Because two adjacent levels exist with a parent-child relationship therebetween, the entire pyramid configuration is further deemed as a tree structure that is also called as the spatial orientation tree. The tree structure has the feature of self-similarity. Self-similarity means that the values of different data points, which are located at different levels but in the same sub-tree, would be approximately the same. Since the higher level in the pyramid configuration is multiplied with a greater weighting value, the numbers in the same sub-tree from the highest level to the lowest level are accordingly have been arranged from the large to small so that the sort process is efficient.

In the tree structure, some parameters are defined as follow:

O (i,j): a set of the sub-coordinate points of node (i,j);

D (i,j): a set of the further sub-coordinate points of node (i,j);

H: a set of coordinate points in the tree roots; and

L(i,j)=D(i,j)−O(i,j).

Except the highest and the lowest level, the remainder O(i,j) is calculated by equation O(i,j)=[(2i,2j),(2i,2j+1),(2i+1,2j),(2i+1, 2j+1)].

Moreover, three types of lists are further defined, wherein the three types are “list of insignificant set (LIS)” that has two categories A and B, “list of insignificant pixels (LIP)” and “list of significant pixels (LSP)”. Moreover, function Sn(x) is defined for representing the importance of the number x, wherein Sn=1 means x is important and Sn=0 means x is unimportant.

An important technique in SPIHIT is “Set Partition Sorting Algorithm”. In this algorithm, all data points in the same sub-tree are placed in the LIS, and then to test if each point, from the highest level to the lowest level, is significant. If the tested point is significant, it is placed to LSP. Otherwise, the insignificant point is placed to LIP. The algorithm is composed of four main steps: the initialization, sorting pass, refinement pass and quantization step update, described as follow.

1) [Initialization]:

$$output n = [ {log}_{2} ( {max}_{( i , j )} ( \vert {c}_{i , j} \vert ) ) ]$$

LSP←φ

LIP←(i,j)|(i,j)εH

LIS←D(i,j)|(i,j)εH (type A)

2) [Sorting Pass]:

2.1) ∀(i,j)εLIP

2.1.1) output Sₙ(i,j)

2.1.2 if Sₙ(i,j)==1 then LSP←(i,j)←LIP

2.2) ∀(i,j)ε=LIS do

2.2.1) if (i,j) is type A (D(i,j)),

then · output Sₙ(D(i,j)), (traverse a tree)

· if Sₙ(D(i,j))==1 then

1. ∀(k,l)εO(i,j) do output Sn (k,l)

· if Sn (k,l)==1 then LSP (k,l)

output the sign of C_{k,l}

· if Sn (k,l)==0 then LIP←(k,l)

2. if L(I,j)≠φ then LIS←(i,j) (type B)

go to 2.2.2)

otherwise (i,j)←LIS

2.2.2) if (i,j) is type B (L(i,j)),

then · output Sₙ(D(i,j)),

if Sₙ(L(i,j))==1 then

1. LIS <type A>←(k,l)(εO(i,j))

$$2. ( i , j ) {⟵}^{remove} LIS$$

3) [Refinement Pass]

∀(i,j)εLSP with the same n:

output the nth most significant bit of |c_{i,j}|

4) [Quantization Step Update]

n←n−1, go to Step 2.

In the step of initialization, several variables are initialized and the bit number of the maximum number in c[ ] is obtained, wherein c[ ] is input.

The second step is to check whether each number in LIP is significant. If so, the number is further placed into LSP. After which, each number in each sub-tree of LIS is also tested to fine out if the tested number is significant. If the entire sub-tree does not include any significant number, the sub-tree is skipped, otherwise the first child level in the sub-tree is tested. If any significant number exists in the child level, the number is placed into LSP. Then, the significant testing process is further applied to test all sub-trees in the child levels. Every significant sub-tree in the child level is further captured out from the child level and then placed into the LIS.

Finally, all significant numbers are transmitted by means of bit plane transmission. The meaning of bit plane transmission is that when transmitting a number, only one bit data of the number is transmitted in every transmitting cycle, that is to say the number must be transmitted with multiple times. Generally, the highest bit data of the number is firstly transmitted. The advantage of such a bit plane transmission is that the user who receives and decodes the data can easily know the approximate size of the transmitted number.

In the field of 3-D graphic transmission, most prior techniques focus on the progressive transmission of 3-D models not on the image texture. In recent years, the image textures are combined with 3-D models to obtain a superior verisimilitude on 3-D graphics. Two conventional arts related to the combination of the image texture and the 3-D model are described hereinafter.

1. Joint Geometry/Texture Progressive Coding of 3-D Models

When a complete 3-D model is divided into multiple triangular regions, each corner of each triangular region would be provided with a corner attribute texture coordinate. Using the model simplify algorithm, such as the vertex clustering and edge collapsing, all vertexes would be tested and considered to determine their significant, where the insignificant vertexes would be culled out and neglected. Such a significant judgement is based on two factors, the size variation v(i) if the vertex is culled out and the color significant c(i). Such a judgement is represented by equation (6):

m(i)=αv(i)+(1−a)c(i) (6)

With reference to FIG. 13, after culling out the insignificant vertexes, the image is rearranged to still have multiple triangular regions. However the number of the rearranged triangular regions is fewer than that of the original ones. When transmitting the model, the transmission priority is according to the significant level of each vertex thereby accomplishing the model and texture image progressive transmission.

2. Texture Mapping Progressive Meshes

With reference to appendix 14, although the foregoing technique can perform the progressive transmission, the image rearrangement would lead to the problem of image deformation. So another manner is presented to overcome the deformation problem.

With reference to FIG. 15, the first step is to partition a model into several charts based on the planarity and the compactness of the original vertexes. Furthermore, the boundary of adjacent charts is rearranged to become a shortest line.

The second step is to rearrange the vertexes' positions of each chart by use of the following equation (7):

$${L}^{2} ( M ) = \sqrt{{\sum }_{{T}_{i} ∈ M} {( {L}^{2} ( {T}_{i} ) )}^{2} / {\sum }_{{T}_{i} ∈ M} {A}^{i} ( {T}_{i} )} \qquad ( 7 )$$

The objective of the second step is to reduce the texture stretch error caused from the change of vertexes and then to stretch each chart to form a 2-D quadrangle unit. After which, each unit is further adjusted to have a proper size.

The third step is to simplify each chart by means of edge collapsing technique. At the same time, the texture deviation due to the consolidation of vertexes must be considered. Such a texture deviation is shown as an example in FIG. 16. When vertexes V1 and V2 are consolidated together, the texture deviation among the three red points should be considered.

The fourth step is to simplify the entire model, i.e. to optimize each level of the model so as to minimize the errors between two adjacent levels.

Finally, in the fifth step, the texture is re-sampled in accordance to the charts so as to reconstruct a complete texture. All the processes mentioned above are shown in the example of FIG. 17.

However, whether the foregoing first type or second type, their objective is aimed at the progressive transmission of model. When meshing the texture over the model, some drawbacks or inconvenience occur.

1. Both the first type and the second type are aimed at the simplification of the model, and then to combine the model with the texture. Since the model and texture are dependent on each other, they are difficult to separate and utilized independently.

2. In the first type, the meshing coordinate is corner attribute texture coordinate not the commonly-used vertex attribute texture coordinate.

3. Since the objective is progressive transmission of model, there is no continuity in texture transmission which leads the image edge to not be smooth.

4. Since each chart is not a quadrangle shape after the texture is divided, so additional data must be provided during the coding transmission. Thus total amount of data to be transmitted is increased.

To overcome the mentioned shortcomings, a texture partition and progressive transmission method applied on the network in accordance with the present invention obviates or mitigates the aforementioned problems.

### SUMMARY OF THE INVENTION

The objective of the present invention is to provide a texture partition and progressive transmission method of a 3-D graphic over the Internet, wherein the Wavelet Coding Algorithm is used to encode the texture image to be displayed with different resolutions so that the 3-D model is conveniently previewed during transfer and a user can terminate the transmission at any time.

To accomplish the objective, the step of the method includes:

image partitioning, wherein an image to be meshed over a 3-D model is partitioned to a plurality of image tiles;

image tile encoding, wherein each image tile is encoded to by means of Wavelet coding to form a data string;

model partitioning, wherein the model is partitioned to a plurality of model tiles to correspond to the plurality of image tiles;

obtaining a feature parameter of each model tile;

resolution determining, wherein the resolution of each image tile is individually determined based on the feature parameter of the corresponding model tile that the image tile is intended to be meshed with;

image tile decoding, wherein each data string is decoded to reconstruct the image tile having the determined resolution; and

image tile pasting, wherein the reconstructed image tiles are correspondingly attached over the model tiles.

Further, the following steps perform an alternative of the method in accordance with the present invention:

model partitioning, wherein a 3-D model is partitioned to a plurality of model tiles;

image partitioning, wherein an texture image belong to the 3-D model is partitioned to a plurality of image tiles to correspond to the plurality of model tiles;

image tile encoding, wherein each image tile is encoded to by means of Wavelet coding to form a data string;

obtaining a feature parameter of each model tile;

resolution determining, wherein the resolution of each image tile is individually determined based on the feature parameter of the corresponding model tile that the image tile is intended to be meshed with;

image tile decoding, wherein each data string is decoded to reconstruct the image tile having the determined resolution; and

image tile pasting, wherein the reconstructed image tiles are correspondingly attached over the model tiles.

The features and structure of the present invention will be more clearly understood when taken in conjunction with the accompanying figures.

### BRIEF DESCRIPTION OF THE DRAWINGS

FIG. 1 is a schematic view of image partition in accordance with the present invention;

FIG. 2 shows each tile is encoded by Wavelet Coding Algorithm in accordance with the present invention;

FIG. 3 is a schematic view of model partition in accordance with the present invention;

FIGS. 4A-4C sequentially show the decoding process to reconstruct an image in accordance with the present invention;

FIG. 5 is a flow chart showing a creating process of a progressive image in accordance with the present invention;

FIG. 6 is a flow chart showing the combination process of the model and the texture;

FIGS. 7A-7C are the computer generated 3-D object in accordance with the present invention;

FIG. 8 is a schematic view showing a pyramid configuration of the S+P transform;

FIG. 9 is a conventional S+P transform schematic view;

FIG. 10 shows the conventional S+P transform process;

FIG. 11 shows a pyramid configuration having a plural levels obtained from the S+P transform;

FIG. 12. shows a weighting value table for keeping all levels in the pyramid configuration as shown in FIG. 8 unitary;

FIG. 13 is a schematic view showing the vertexes rearrangement;

FIG. 14 shows the distortion caused from the vertexes rearrangement;

FIG. 15 is a schematic view showing the conventional model partition;

FIG. 16 is a schematic showing the texture deviation; and

FIG. 17 shows a conventional reconstruction process of a 3-D texture image.

### DETAILED DESCRIPTION OF THE PREFERRED EMBODIMENT

The present invention is a texture partition and progressive transmission method for 3-D model with texture over the internet, which mainly includes the steps of texture partitioning, texture encoding, model partitioning, feature parameter obtaining, resolution determining, texture decoding, texture meshing etc.

The detailed description for each step is introduced hereinafter.

1. Texture Partitioning

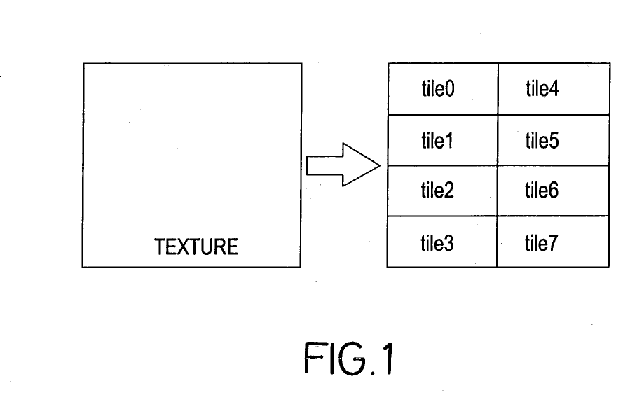

With reference to FIG. 1, in order to accomplish the objective of the progressive transmission, a texture to be attached to a 3-D model is partitioned to multiple subtextures and each subtexture is denominated “tile” hereinafter.

2. Wavelet Encoding

A texture is basically composed of high frequency information and low frequency information. The low frequency information is able to present a brief outline of the texture. The high frequency information, which contains the feature information of the texture, is applied to modify the brief outline generated by low frequency information so that the texture is shown in detail and texture definition is enhanced.

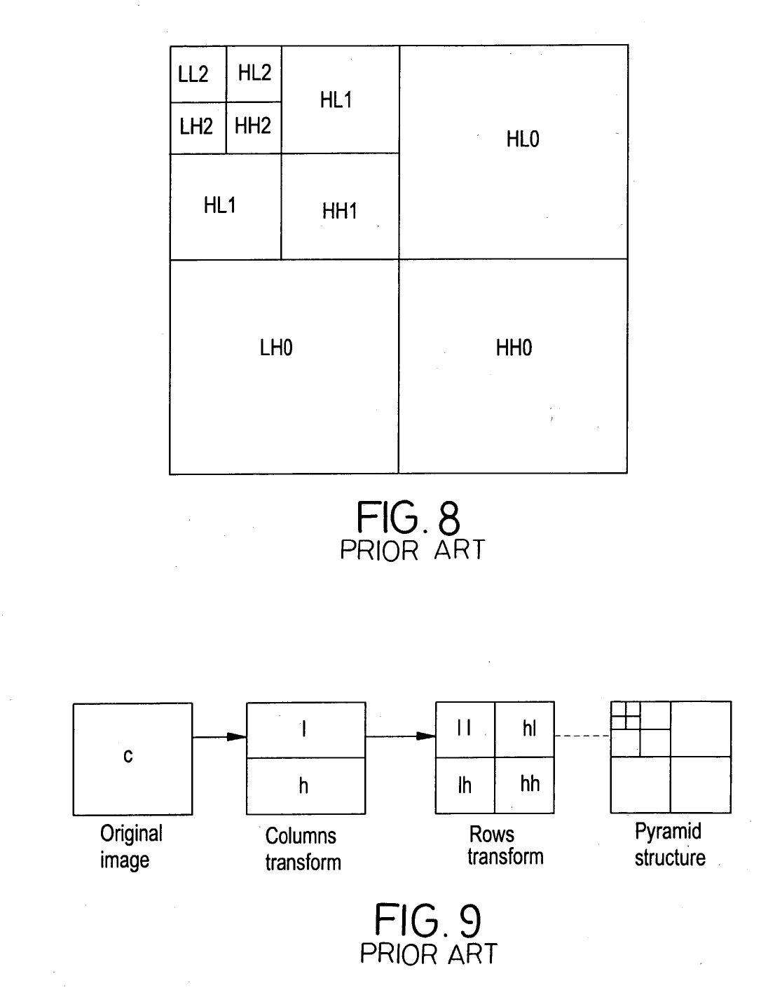

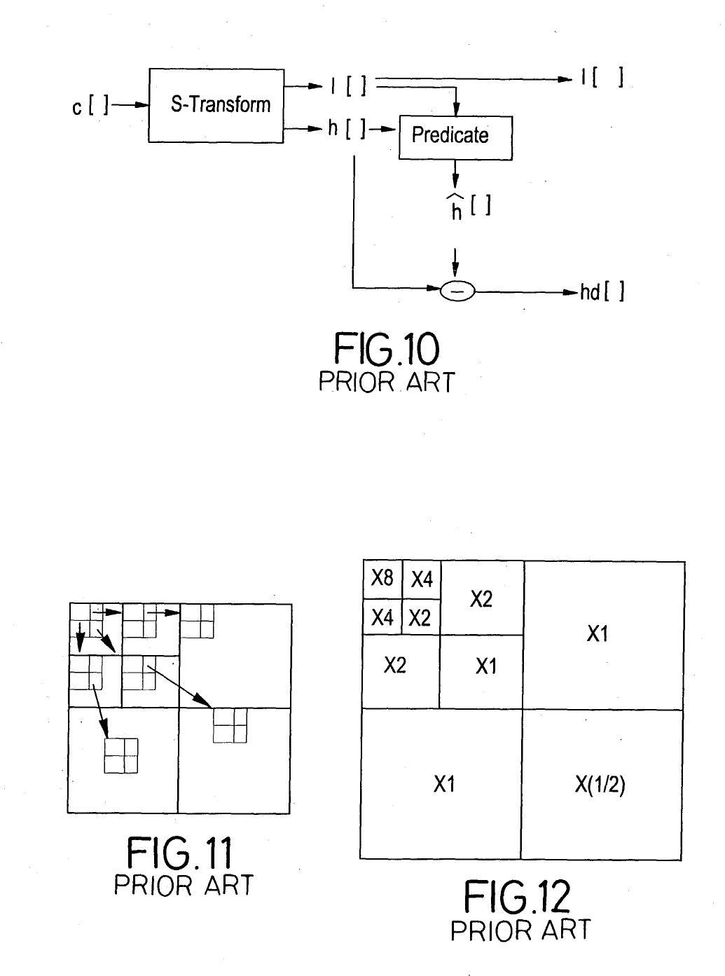

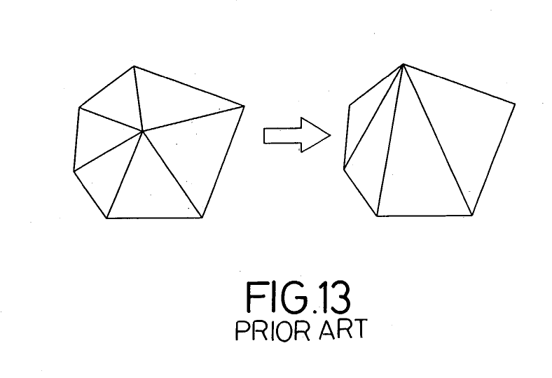

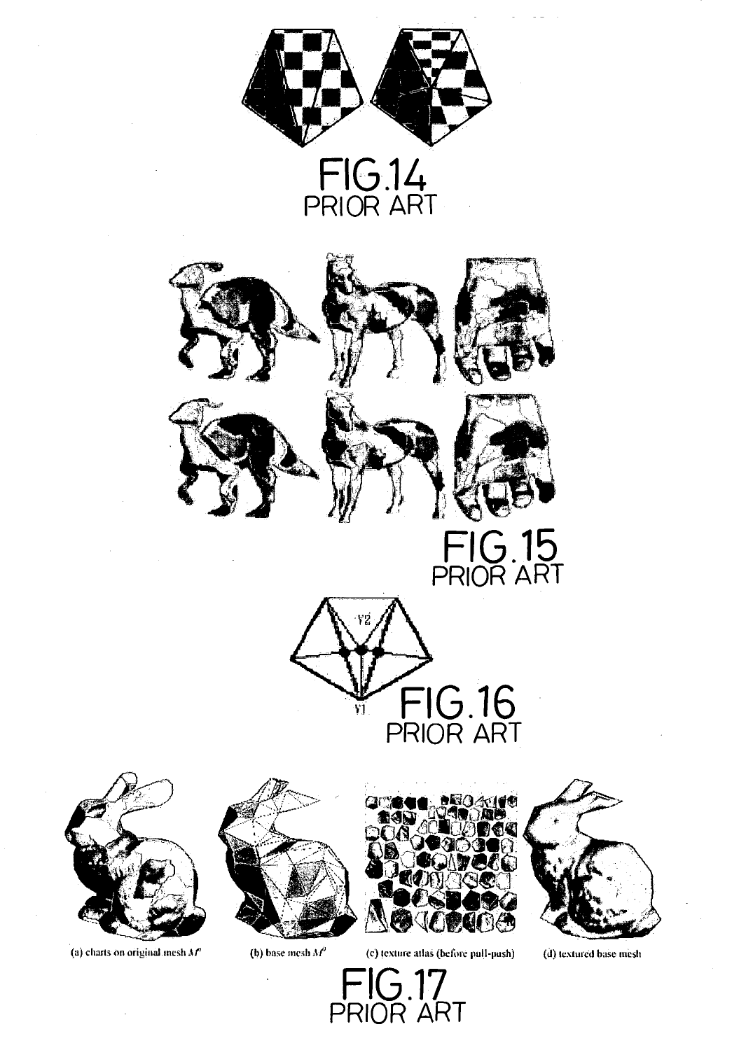

When an image is transferred by S+P transform, the image is represented by frequency domain and has a pyramid configuration with a plurality of levels to represent different resolutions, level 0 to level N (LV0-LVN, as shown in FIG. 8).

The higher level it is, the lower frequency information is contained in the level. Therefore, when the image transmission starts from the level N (LVN) to level 0 (LV0), the image gradually becomes clear.

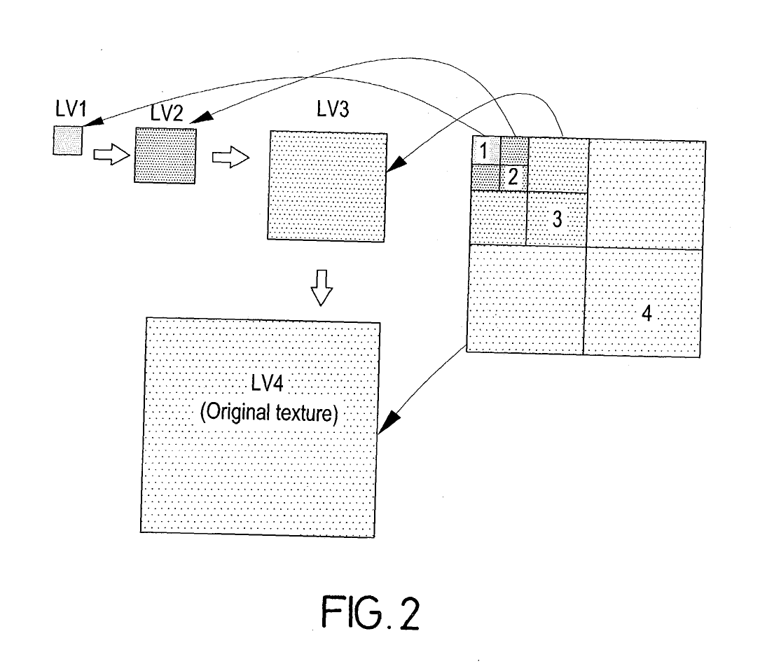

With reference to FIG. 2, each tile is encoded by Wavelet encoding to form a data string. The encoding step is performed by the following detail steps:

converting each tile by S+P transform to form a pyramid construction;

sorting all numbers in LLN that contain the low frequency information by SPIHT and encoding each sorted number by arithmetic encoding;

respectively sorting all numbers in LH^{N-1}, HL^{N-1} and HH^{N-1} in the level N (LV N) by SPIHT and encoding each sorted number by arithmetic encoding;

respectively sorting all numbers in LH^{N-1}, HL^{N-1} and HH^{N-1} in the next level, the level N−1 (LV N−1), by SPIHT and encoding each sorted number by arithmetic encoding; and

sorting and encoding the LH, HL and HH of the remaining levels sequentially, until all levels (level N−2 . . . level 1, level 0) are finished.

Thereafter, each tile is converted into a data string with the configuration shown as below:

| | | | | |
|---|---|---|---|---|
| LL^{N} | LH^{N} [symbol] HL^{N} [symbol] HH^{N} | LH^{N-1} [symbol] HL^{N-1} [symbol] HH^{N-1} | . . . | LH⁰ [symbol] HL⁰ [symbol] HH⁰ |

3. Storing Data String

Each data string is then stored in a storage media such as a hard disk for any further application. Therefore, each image tile is able to be individually and repeatedly used.

4. Obtaining a Model

Open a file of a 3-D model on which the texture is intended to be pasted.

5. Partitioning the Model

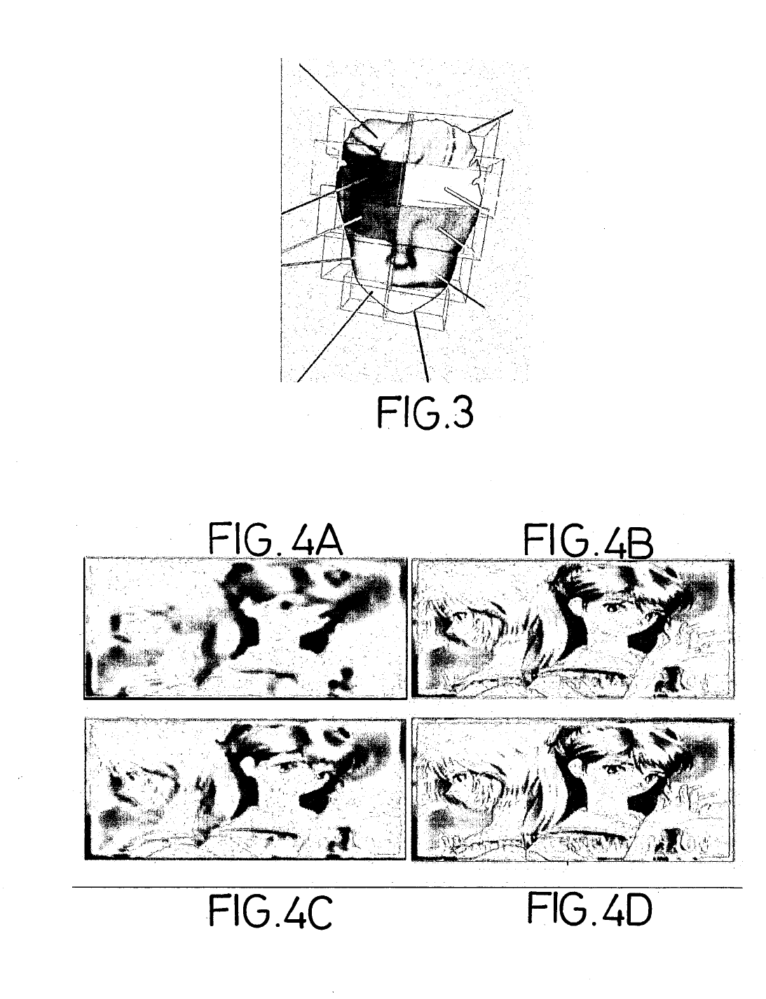

Based on the image partition as mentioned foregoing, the 3-D model is also correspondingly divided into multiple meshes (as shown in FIG. 3), where each mesh is also called as model tile hereinafter. As an example, the 3-D model partition is performed based on the texture coordinate. Further, a feature parameter of each model tile is further obtained from the model tile feature. For instance, the feature parameter can be obtained from the bounding box of the model tile, the radius value of the model tile, or the representative vector thereof, etc.

6. Level Determining

As mentioned above, each image tile is converted to a data string expressed by N levels representing different resolutions. Based on each obtained feature parameter of each model tile and the user's requirements such as the viewpoint and the position, the desired resolution of each model tile is determined. The desired display level in the data string is further decoded to reconstruct an image tile with the desired resolution. Then, the reconstructed image is stored in the cache memory to be repeatedly used.

For example, if the bounding box, radius value and representative vector are the principles for the feature parameter determination, the factors of the size of the 3-D object, the distance between the viewpoint and the 3-D object, and the representative vectors of the object may be all considered. By properly adjusting the weighting among all factors, the desired feature 6 parameter is decided.

7. Wavelet Decoding

After the display level of each image tile is determined, each data string is decoded to reconstruct and form an image tile with desired resolution. Each reconstructed image tile may displayed by a desired resolution that differs from its original resolution. The decoding process is an inverse process of S+P transform, and as explained below: decoding the LL^{N} in the data string by arithmetic decoding manner, then input the decoded LL^{N} into the inverse S+P transform to reconstruct an image tile;

decoding the LH^{N-1}, HL^{N-1} and HH^{N-1} of the level N (LV N) in the data string by arithmetic decoding manner, then input them into the inverse S+P transform to reconstruct an image tile for modifying the previous reconstructed image tile;

repeatedly decoding the LH, HL and HH of the remaining levels until the image tile having the desired resolution is obtained, wherein if all levels are decoded, the reconstructed image tiles have the highest resolution the same as the original image tile.

With reference to FIGS. 4A-4D, in this example the total resolution level is four. During the image reconstruction period, the image gradually becomes clear according to the increase of the solution.

8. Combination of the Image Tile and Model Tile

After all reconstructed image tiles with the desired resolution are obtained, these image tiles are respectively pasted up the model tiles. As a result a complete 3-D model with texture is formed.

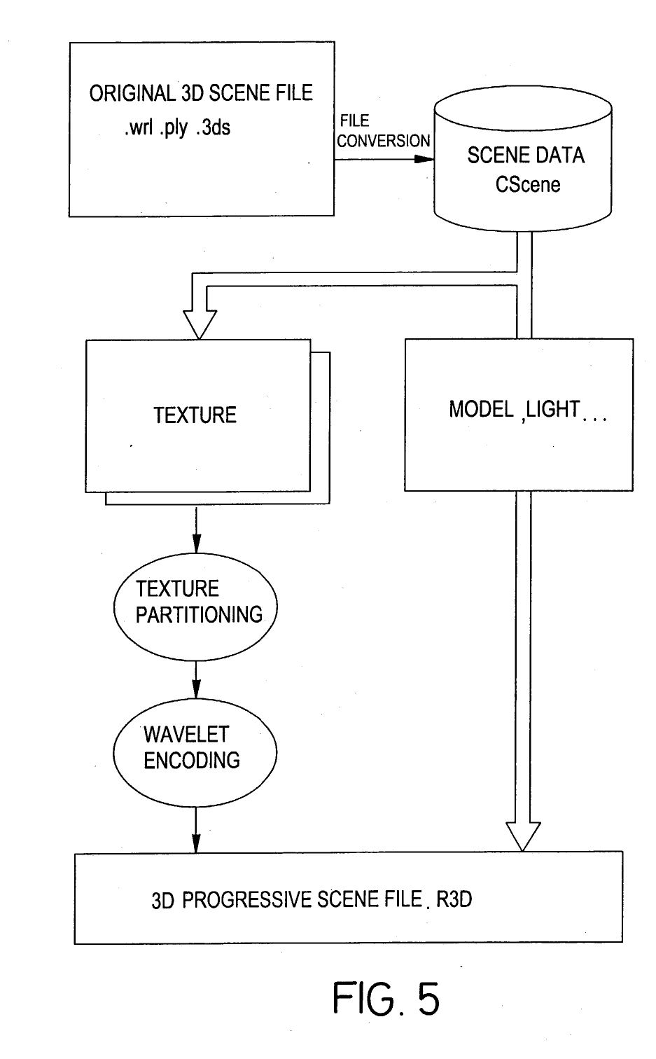

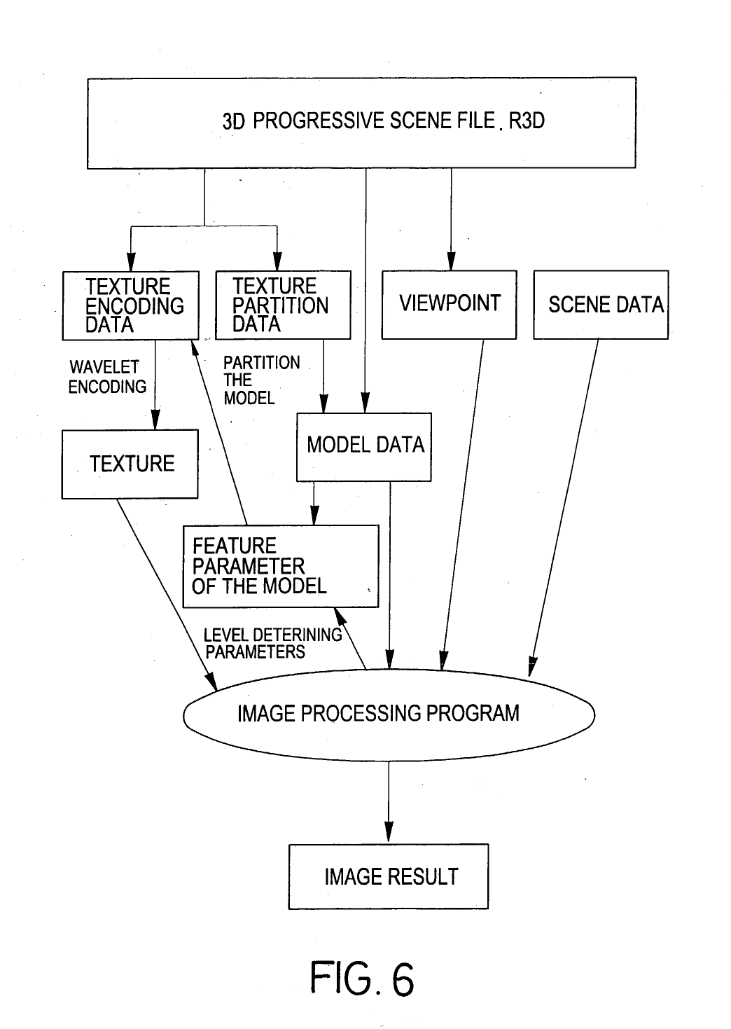

From the foregoing description, the method is mainly composed of two aspects, one is to create an image capable of presenting multiple resolutions, and the other aspect is to combine the image with a 3-D model to show the desired resolution based on the user's requirement. The entire process of the method in accordance with the present invention is expressed by FIGS. 5 and 6.

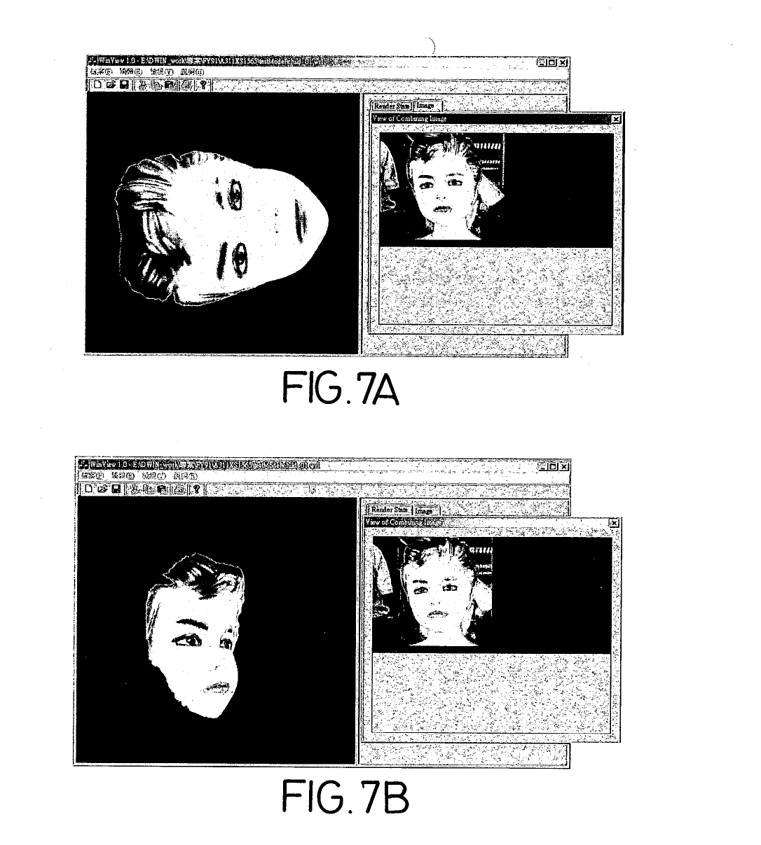

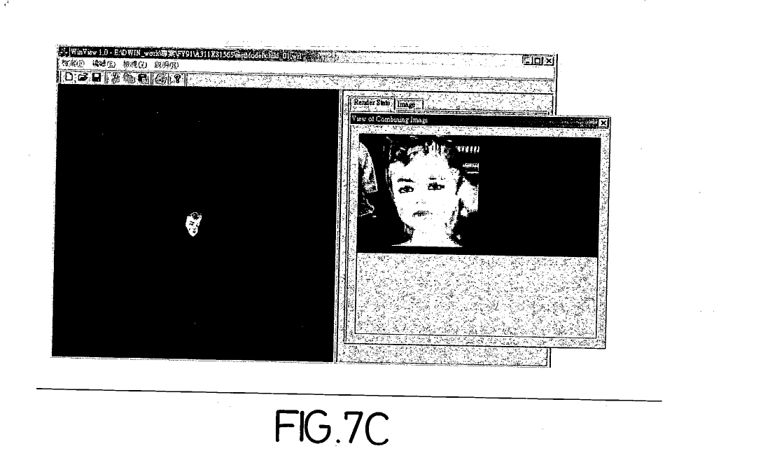

With reference to FIGS. 7A-7C, FIG. 7A shows an original 3-D scene model. FIG. 7B shows the compressed and transmitted 3-D scene model, wherein the texture level is determined by the factor of viewpoint. Further, FIG. 7C shows another result when the viewpoint is changed.

It is noted that in the foregoing description, the image partition process is performed before the model partitions process. However it is appreciated that the sequence of the two processes are exchangeable.

In conclusion, the present invention provides a progressive transmission in the 3-D graphic field to allow a user preview the image during the transfer so that the transfer can be terminated at an early stage.

The foregoing description of the preferred embodiments of the present invention is intended to be illustrative only and, under no circumstances, should the scope of the present invention be restricted by the description of the specific embodiment.

What is claimed is:

1. A texture partition and transmission method for network progressive transmission and real-time rendering by using Wavelet Coding Algorithm, the method comprising the steps of:
image partitioning, wherein an image to be meshed over a 3-D model is partitioned to a plurality of image tiles; and
image tile encoding, wherein each image tile is encoded to by means of the Wavelet Coding Algorithm to form a data string that contains a plurality of levels representing different resolutions;
whereby when all image tiles are pasted up the 3-D model, each image tiles is individually displayed by a desired resolution.

2. The method as claimed in claim 1, wherein after the step of image partitioning, the 3-D model is partitioned to a plurality of model tiles to correspond to the plurality of image tiles.

3. The method as claimed in claim 2 further comprising a step of display resolution determining, wherein when one of the image tiles is correspondingly pasted up one of the model tiles, a display resolution of the image tile is determined by a feature parameter of the model tile.

4. The method as claimed in claim 3, the method further comprising:
image tile decoding, wherein each data string is decoded to reconstruct the image tile having the determined display resolution based on the feature parameter; and
image tile pasting, wherein all reconstructed image tiles are correspondingly pasted up the model tiles.

5. The method as claimed in claim 1, before the step of image partitioning, the 3-D model is partitioned to a plurality of model tiles.

6. The method as claimed in claim 2 further comprising a step of display resolution determining, wherein when one of the image tiles is correspondingly pasted up one of the model tiles, a display resolution of the image tile is determined by a user.

7. The method as clamed in claim 4, wherein each image tile is a block-shaped tile.

8. The method as clamed in claim 5, wherein each image tile is a block-shaped tile.

9. The method as claimed in claim 4, wherein in the image tile encoding step, each image tile is defined to have N resolution levels so that the encoded data strings have N segments.

10. The method as claimed in claim 5, wherein in the image tile encoding step, each image tile is defined to have N resolution levels so that the encoded data strings have N segments.

11. The method as claimed in claim 9, wherein the image tile encoding step further comprising:
converting each image tile by S+P (transform to form a pyramid construction);
sorting all numbers in LL^{N} that contains low frequency information of the image tile by SPIHT and encoding each sorted number by arithmetic encoding;
respectively sorting all numbers in LH^{N-1}, HL^{N-1} and HH^{N-1} in the highest level N by SPIHT and encoding each sorted number by arithmetic encoding;
respectively sorting all numbers in LH^{N-1}, HL^{N-1} and HH^{N-1} in a subsequent level, the level N−1 (LV N−1), by SPIHT and encoding each sorted number by arithmetic encoding; and
sorting and encoding the LH, HL and HH of remaining levels sequentially, until all levels (level N−2 . . . level 1, level 0) are finished.

12. The method as claimed in claim 10, wherein the image tile encoding step further comprising:
converting each image tile by S+P (transform to form a pyramid construction);
sorting all numbers in LL^{N} that contain low frequency information of the image tile by SPIHT and encoding each sorted number by arithmetic encoding;
respectively sorting all numbers in LH^{N-1}, HL^{N-1} and HH^{N-1} in the highest level N by SPIHT and encoding each sorted number by arithmetic encoding;
respectively sorting all numbers in LH^{N-1}, HL^{N-1} and HH^{N-1} in a subsequent level, the level N−1 (LV N−1), by SPIHT and encoding each sorted number by arithmetic encoding; and
sorting and encoding the LH, HL and HH of the remaining levels sequentially, until all levels (level N−2 . . . level 1, level 0) are finished.

13. The method as claimed in claim 4, wherein in the 3-D model is partitioned to the plurality of model tiles based on a texture coordinate of the 3-D model.

14. The method as claimed in claim 5, wherein in the 3-D model is partitioned to the plurality of model tiles based on a texture coordinate of the 3-D model.

15. The method as claimed in claim 4, wherein in the feature parameter is chosen from a group consisting of a bounding box of the model tile, a radius value of the model tile and a representative vector of the model tile.

16. The method as claimed in claim 5, wherein in the feature parameter is chosen from a group consisting of a bounding box of the model tile, a radius value of the model tile and a representative vector of the model tile.
